(19) United States
(12) Patent Application Publication
(10) Pub. No.: US 2008/0110348 A1
(43) Pub. Date: May 15, 2008

(54) Egg making device

(75) Inventor: David J.B. Wallis, Chevy Chase, MD (US)

Correspondence Address: CROWELL & MORING LLP;INTELLECTUAL PROPERTY GROUP, P.O. BOX 14300, WASHINGTON, DC, 20044-4300, US

(73) Assignee: David J.B. WALLIS, Chevy Chase, MD (US)

(21) Appl. No.: 11/905,176

(22) Filed: Sep. 27, 2007

Related U.S. Application Data
(60) Provisional application No. 60/847,375, filed on Sep. 27, 2006.

(51) Int. Cl. A47J 29/00; A47J 43/04; A47J 29/02; A23L 1/01; A23L 1/32

(52) U.S. Cl. 99/352; 99/348; 99/332; 426/510; 426/614

(57) ABSTRACT

An egg making assembly, comprising: a refrigerating container holding chilled eggs at a predetermined temperature; a cooking container; a portioning mechanism structured and arranged to supply a predetermined measured amount of egg from the refrigerating container to the cooking container; a controller coupled to the portioning mechanism to selectively activate the portioning mechanism; a steam supplying device contacting the egg in the cooking container to cook the egg; and a dispensing mechanism coupled to the cooking container to move the cooking container between a cooking position and an dispensing position to permit a consumer to access the cooked egg, and a method of making eggs, comprising: positioning eggs within a chilled container at a predetermined temperature; selectively activating a controller to supply a predetermined portion of egg to a cooking container; cooking the predetermined portion of egg with steam; moving the cooking container between a cooking position and an dispensing position to permit a consumer to access the cooked egg.

### FIELD OF THE INVENTION

The present invention relates to an egg making device. More specifically, the invention relates to a device to cook eggs to order.

### BACKGROUND OF THE INVENTION

Current egg making devices and methods fall short in many areas. Eggs left on a buffet table quickly become hard and leathery in texture and thus unappetizing. The result is that large quantities of eggs are wasted and the customers receive a poor option for their meal and are generally dissatisfied with the quality of the buffet. Further the constant cooking and replacement of the hard unappealing eggs takes unnecessary manpower and costs.

Current egg making devices include those disclosed in U.S. Pat. No. 4,233,891 to Schindler et al. U.S. Pat. No. 4,228,193 to Schindler et al.; U.S. Pat. No. 6,759,076 to Sanderson et al.; U.S. Pat. No. 5,427,016 to Dunckel; and U.S. Pat. No. 5,054,384 to Smith, Jr., each of which is incorporated herein by reference in its entirety, respectively. The devices disclosed in the above mentioned patents fail to address the shortcomings of known egg making device. The present invention addresses these shortcomings and provides a novel egg making device.

### SUMMARY OF THE INVENTION

One aspect of the invention relates to an egg making assembly, comprising: a refrigerating container holding chilled eggs at a predetermined temperature; a cooking container; a portioning mechanism structured and arranged to supply a predetermined measured amount of egg from the refrigerating container to the cooking container; a controller coupled to the portioning mechanism to selectively activate the portioning mechanism; a steam supplying device contacting the egg in the cooking container to cook the egg; and a dispensing mechanism coupled to the cooking container to move the cooking container between a cooking position and an dispensing position to permit a consumer to access the cooked egg.

Another aspect of the invention relates to a method of making eggs, comprising: positioning eggs within a chilled container at a predetermined temperature; selectively activating a controller to supply a predetermined portion of egg to a cooking container; cooking the predetermined portion of egg with steam; moving the cooking container between a cooking position and an dispensing position to permit a consumer to access the cooked egg.

Other aspects, features, and advantages of this invention will become apparent from the following detailed description when taken in conjunction with the accompanying drawings, which are a part of this disclosure and which illustrate, by way of example, the principles of this invention.

### BRIEF DESCRIPTION OF THE DRAWINGS

The accompanying drawings facilitate an understanding of the various embodiments of this invention. In such drawings,

FIG. 1 shows a front view of one embodiment of a device in accordance with the present invention;

FIG. 2 shows a side view of the device of FIG. 1; and

FIG. 3 shows the a example of an operational cycle of the device of FIG. 1.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

In accordance with one embodiment of the present invention, the device 10 provides fresh scrambled eggs on demand. For buffet breakfasts serviced at places, such as, hotels, restaurants, on cruise ships, this solves several problems mentioned above with respect to prior art devices.

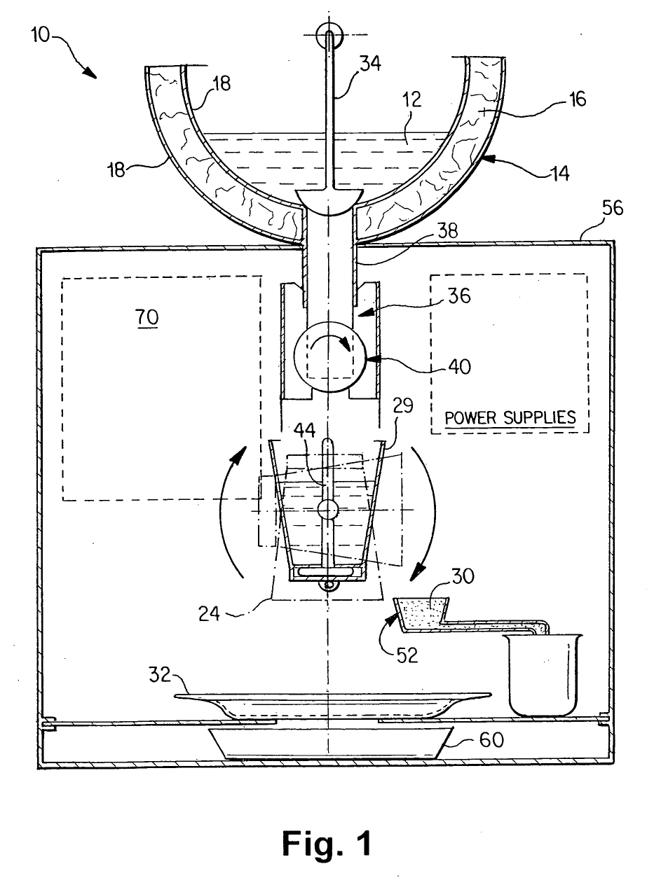

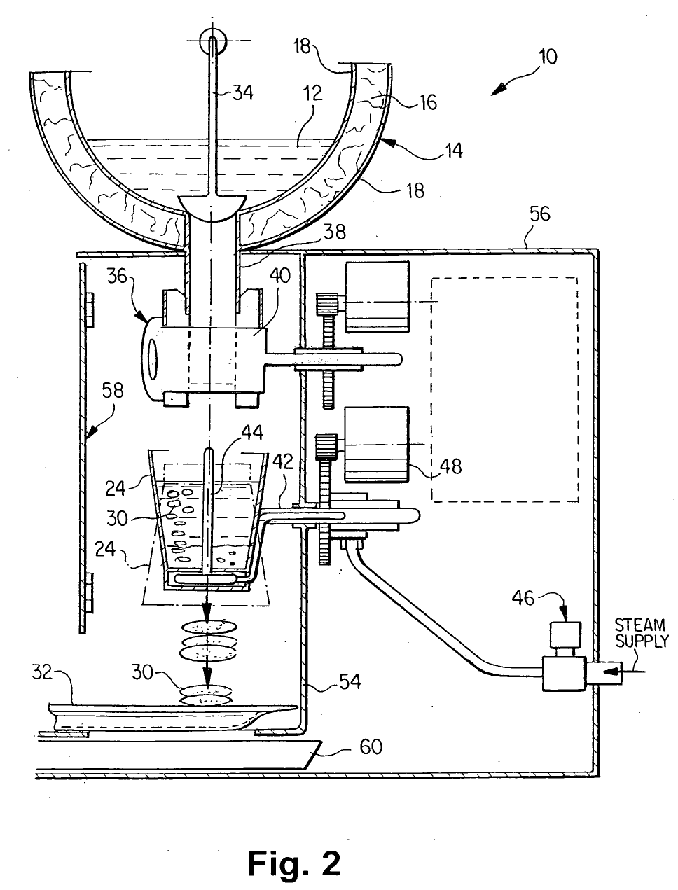

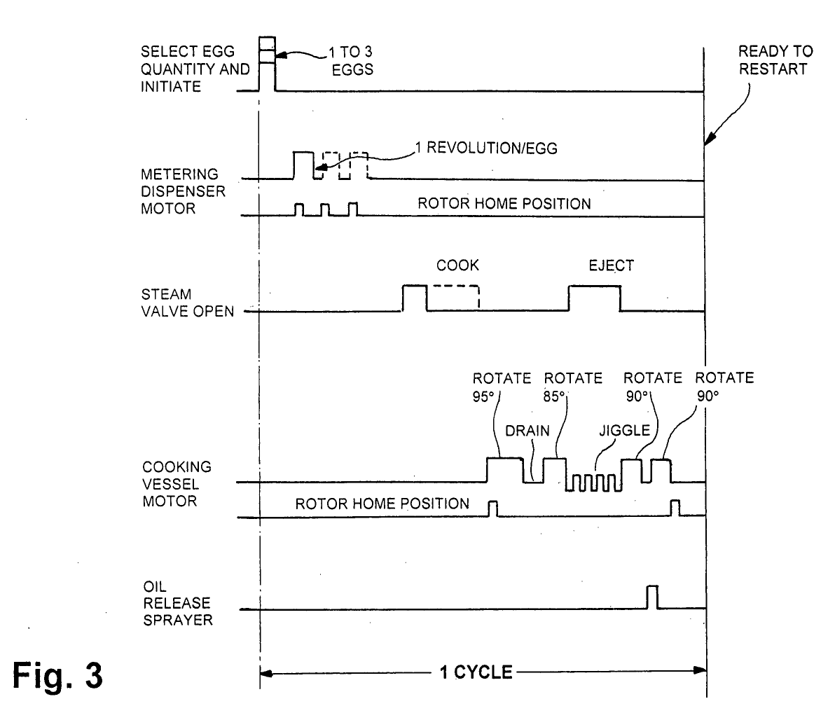

The device 10 may take various configuration. In the illustrated embodiment of FIGS. 1-3, the device 10 includes a main housing that accepts raw egg mixture 12 in a top bowl or holding tank 14 and meters and dispenses this liquid into an upright cooking vessel 24 where it is cooked (e.g., scrambled) by steam injection. The vessel 24 may automatically be moved (e.g., turned upside down), allowing the now solid egg mass 30 to be accessed by a user (e.g., fall on to a serving dish 32 for the user).

The device 10 may, for example, provide an option for determining the number of eggs desired to be served (e.g., one, two, or three eggs, or more), flavoring options, such as a butter flavoring option, and cooking time options (e.g., moist or extra cooking). All of the desired options would provide eggs on demand within a relatively short time, for example, five (5) to ten (10) seconds.

Device 10 may have several sizes to coincide with dining establishments volume needs. As illustrated, the device 10 includes a holding tank 14 where the eggs 12, minus shells, are loaded. In the illustrated embodiment, the input liquid egg mixture 12 is poured into the top bowl or holding tank 14, which may be double walled containing ice for cooling. The holding tank 14 may take various forms and may include configurations providing refrigeration, such a double skin tank, as illustrated, with ice 16 and water positioned in the gap between the skins 18. Another alternative may provide for a conventional electric refrigeration coil system to cool the tank 14. Holding tank 14 may include a stirring wand to keep mixing the scrambled eggs 12 and to maintain a consistency with the scrambled eggs 12. Each holding tank 14 may feature a pump capable of accurately measuring a predetermined quantity of eggs 12 as desired (e.g., one (1), two (2) or three (3) eggs, or more) and to pump the desired number of eggs 12 into a cooking chamber 24. In the illustrated embodiment, a stopper 34 is raised allowing this liquid 12 to descend into a metering valve 36. When the stopper 34 is lowered, liquid flow is stopped, allowing the bowl 14 and filling tube 38 to be removed, for example, for cleaning.

The egg metering dispenser 36 may be a motor driven rotary valve whose chamber admits the liquid equivalent of one egg (about 3 cu. in.) for each revolution of the drive motor, for example, 3 eggs dispensed equals 3 revolutions. The liquid egg 12 is dispensed to the cooking vessel 24 below after one half revolution when the valve chamber is open downward. The valve core 40 may be easily removable for periodic cleaning.

The cooking chamber 24 may be, for example, a cylindrical chamber, open on one end. With the ordered volume of eggs 12 in the cooking chamber 24, steam is applied to the cooking chamber 24. The cooking chamber 24 may take various forms and include, for example, a lining of non-stick Teflon.

The illustrated cooking vessel 24 is a cup formed of any appropriate material, such as stainless steel. The cup 24 can be any size, and may be sized for example, to hold the liquid equivalent of six eggs (scrambled eggs can approximately double in volume from the liquid equivalent). This cup 24 may be held by a horizontal rotating shaft 42 (shown in side view) which may be motor driven and programmed to rotate through 360 degrees and stop at several pre-determined positions. Steam under pressure, flows through the horizontal shaft 42, sealed by a rotary steam joint, and is piped into the bottom of the cup 24 and distributed to appropriately sized and spaced jet holes 44. The rising steam bubbles up through the liquid egg mixture 12, cooking this into a solid, fluffy egg mass 30 producing scrambled eggs. Steam, from an external boiler, is controlled by an electric valve 46, which may be programmed to open and close as required. A programmed stepper motor 48 rotates the shaft 42 and cup 24 through multiple positions. The positions may vary, but five positions are illustrated as follows: 1. Start at initial position-0 degrees-where liquid egg 12 pours into the cup 24 and steam is injected; 2. Rotate to about 100 degrees where unwanted remaining liquid 50 (condensed steam and any uncooked egg) runs into a liquid residue collection cup 52; 3. Rotate to 180 degrees where cup 24 is upside down. Egg mass 30 falls to plate 32 below. (Stepper motor 48 may be rapidly pulsed forward and backward a few degrees to shake or vibrate all egg matter 30 loose); 4. Rotate to 270 degrees (optional) where cooking oil (such as Pam®) may be sprayed into cup 24 to lubricate it for next egg batch; 5, Rotate to 360 degrees or initial 0 degrees start position for next egg cycle. The time to complete a full cooking cycle will vary depending on various factors, but if eggs can be cooked in 20 seconds, for example, a full 5-step cycle may be completed in 26-28 seconds. Also, the cooking cup 24 and shaft 42 may be easily removed for periodic cleaning.

The principle parts of the main housing described above may be mounted on a vertical panel 54, such as a stainless steel panel. This may, in turn, be enclosed by a cabinet 56 with a hinged front door 58 for access and for cleaning. This may also be formed, for example, of stainless steel. This cabinet 56 may have a slot for insertion and removal of the serving dish 32 and collection tray 60 immediately below to catch any egg spill over. The cabinet 56 may also house electronic controls and power supplies to operate all mechanisms.

The electronic controls may be a small microprocessor 70 based PCB which is externally programmable to perform the functions shown in the sequence and timing diagram. The user input may be a push button selection for the number of eggs (e.g., 1, 2 or 3 eggs) and a start button. The PCB, in timed sequence, may run the dispensing motor, the cooking vessel motor, and steam valve to complete the egg scrambling cycle. One version of this PCB may have plug-in capability to a computer and keyboard for program tinning and optimization.

Steam may be supplied in a variety of ways. One embodiment may employ a commercially available steam generator, such as, a Reimers Electric Steam Model ABH4EJA which can produce 15 psi from a 1.5 gallon water tank. This generator may be positioned within the main housing 56 and be connected in a flexible manner, for example, by a flexible metal hose.

As mentioned above various configuration of device 10 may be employed. For example; another configuration may employ a different type of movable cooking chamber 24, such as wherein a chamber 24 is be moved, via an arm attachment to relocate the chamber 24 under a mechanized steam arm. The steam arm may then activate and drop into the cooking chamber to a predefined depth according to the volume of eggs in the cooking chamber. Through a group of ports, pressured steam may then exit the arm and cook the eggs within a few a seconds. The arm may then withdraw and the cooking chamber may again move/rotate to the next location where it may be inverted above a chute. The eggs will then drop from the cooking chamber down through the chute onto a plate.

The foregoing embodiments have been provided to illustrate the structural and functional principles of the present invention, and are not intended to be limiting. To the contrary, the present invention is intended to encompass all modifications, alterations, and substitutions within the scope of the appended claims. While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A device for cooking eggs, comprising:
a container for holding eggs;
a container for cooking eggs;
a portioning mechanism structured and arranged to supply a predetermined measured amount of egg from said container for holding eggs to said container for cooking eggs;
a steam supplying device contacting the egg in said cooking container to cook the egg; and
a dispensing mechanism coupled to said cooking container to move the cooking container between a cooking position and an dispensing position to permit a consumer to access the cooked egg.

2. The device of claim 1, wherein the container for holding eggs holds the eggs at a predetermined temperature.

3. The device of claim 2, wherein the container for holding eggs is chilled or refrigerated.

4. The device of claim 1, further comprising a controller coupled to said portioning mechanism to selectively activate said portioning mechanism.

5. The device of claim 4, wherein the controller allows the user to determine the number of eggs desired to be served.

6. The device of claim 1, further comprising a means for controlling the cooking time of the eggs.

7. The device of claim 1, further comprising a means for providing additional flavoring to the eggs.

8. The device of claim 1, wherein the container for holding eggs comprising a means for stirring the eggs.

9. The device of claim 1, wherein the portioning mechanism is a pump.

10. A device for cooking eggs, comprising:
a chilled or refrigerated container for holding eggs at a predetermined temperature;
a container for cooking eggs;
a pump structured and arranged to supply a predetermined measured amount of egg from said chilled or refrigerated container to said container for cooking eggs;
a controller coupled to said portioning mechanism to selectively activate said portioning mechanism;
a steam supplying device contacting the egg in said cooking container to cook the egg; and
a dispensing mechanism coupled to said cooking container to move the cooking container between a cooking position and an dispensing position to permit a consumer to access the cooked egg.

11. The device of claim 10, wherein the controller allows the user to determine the number of eggs desired to be served.

12. The device of claim 10, further comprising a means for controlling the cooking time of the eggs.

13. The device of claim 10, further comprising a means for providing additional flavoring to the eggs.

14. The device of claim 10, wherein the container for holding eggs comprising a means for stirring the eggs.

15. A method of making eggs, comprising:
positioning eggs within a chilled container at a predetermined temperature;
selectively activating a controller to supply a predetermine portion of egg to a cooking container;
cooking the predetermined portion of egg;
moving the cooking container between a cooking position and an dispensing position to permit a consumer to access the cooked egg.

16. The method of claim 15, wherein the egg is cooked with steam.

17. The method of claim 15, further comprising the step of selecting an additional flavoring for the eggs.
